(19) United States
(12) Patent Application Publication
(10) Pub. No.: US 2013/0245504 A1
(43) Pub. Date: Sep. 19, 2013

(54) Touch-and-Hold and stretch-and-hold of the precision method

(71) Applicant: Emerson M.F. Jou, Honolulu, HI (US)

(72) Inventor: Emerson M.F. Jou, Honolulu, HI (US)

(21) Appl. No.: 13/986,447

(22) Filed: May 2, 2013

Related U.S. Application Data
(63) Continuation-in-part of application No. 12/220,376, filed on Jul. 24, 2008, now abandoned.

(51) Int. Cl. A61H 1/00

(52) U.S. Cl. CPC A61H 1/00
USPC 601/1

(57) ABSTRACT

A method for treatment of pain, comprising locating the painful site in an animal or human body and applying the Touch-and-Hold and Stretch-and-Hold of The Precision Method with constant light touch precisely to the injured tissue at the site and holding still for a duration at the site, giving the body a signal so that the injured tissue at the site responds to the “touch” and softens during the duration of the “hold”, thus, effectively resolve pain.

### CROSS-REFERENCE TO RELATED APPLICATIONS

This application is a continuation in part of U.S. patent application Serial No. 12/220,376, filed Jul. 24, 2008, the entire contents of which are incorporated herein by reference.

### FIELD OF THE INVENTION

The present invention is generally related to methods for treatment of pain, more particularly, to a precision method with touch-and-hold technique, supplemented by stretch-and-hold technique when medically indicated, for treating acute and chronic pain as well as pain-related conditions.

### BACKGROUND OF THE INVENTION

There is a misconception among healthcare providers and general public about the causes of pain. In automobile and work-related accidents, sports injuries, slips and falls, contrary to current understanding and common belief, pain is actually derived from soft tissue (more precisely, muscle and fascia) injury. Disc herniation, pinched nerve, sciatica, bone spur, arthritis and inflammation (tendinitis, bursitis) are rarely accounted as the sources of pain. Therefore, the traditional treatments geared to the above causes, such as medications (anti-inflammatory agents, analgesics, muscle relaxants), steroid injection, physical therapy (heat, ultrasound, electrical stimulation, massage, strengthening exercises, etc.), chiropractic manipulation and surgery are largely ineffective in resolving the true sources of pain. Thus, pain remains unresolved for years. Diagnosis and treatment must be focused on soft tissue injury, whereas new and effective approach must be initiated and practiced.

A “precision method” is herein disclosed to overcome the problems mentioned above. The Precision Method, both the theory and its application in patients, has been developed and established by the current inventor, who is a board-certified specialist in Physical Medicine & Rehabilitation and has expertise with more than 35 years of experience in the diagnosis and treatment of soft tissue injury. Using such a method, he has treated many thousands of patients and achieved 90-100% success rate. His unique Precision Method has been proven to be so effective in resolving the true sources of pain that no patient should ever have to learn to live with pain.

### SUMMARY OF THE INVENTION

It is one object of the present invention to provide a precision method for treatment of pain with a touch-and-hold technique precisely at the injured or painful (pain is where the injury is, and vice versa) sites, giving the body a signal so that it will respond and soften, eventually releasing and resolving the injury with no more pain.

The scope of pain in the current invention is focused on soft tissue injury, excluding bone fracture, joint dislocation, ligament or tendon tear, infection, visceral diseases.

The pain is re-defined in the current invention and expanded into three categories as follows:

1. Apparent pain—The kinds of pain we are all familiar with include sharp pain, throbbing pain, aching pain, dull pain, cramps, etc. Pain can be felt at rest or especially upon active and/or passive motion. At the painful site, there is marked tenderness obviously palpable, indicating an injury.

2. Subtle symptom of pain—There are various types of unassuming subtle feelings, such as: slight discomfort, minor aching, aching upon exertion, stiffness, tightness, clumsiness, altered sensation (numbness, tingling, itching, hotness, burning, warmth, coldness, chillness, hypersensitivity, funny feeling, “something not quite right” feeling, altered sense of taste/smell), noise in joint/ear/throat/head, etc. At each of these sites, there is marked tenderness, indicating an injury.

3. Subtle sign of pain—Although no apparent pain or subtle symptom, there are some signs that something is not quite normal, such as: tight muscle, muscle nodule, soft tissue bulge (not inflammatory swelling), postural change (kyphosis, scoliosis), poor balance and gait deviation (limping, shuffling), muscle twitching (facial tic), shaking (restless legs), limited movement (frozen shoulder, trigger finger), limited strength or weakness (knee buckling, drooping eyelids), lack of strength similar to paralysis, easy fatigue, limited endurance in prolonged or repetitive activities, etc., and even general presentation (anxiety, depression, insomnia, hypertension, dizziness). Marked tenderness can be identified at the related site, indicating an injury.

Fascia is little-known in the medical field but plays a very important role in pain, especially the kind of severe sharp pain with or without limited movements. It covers the surface of organs, primarily the entire musculoskeletal structure, fills the space in between the body components, holding them together, so it is also called “connective tissue”. It exists between skin and muscle, skin and bone, muscle bundle and the neighboring bundles, joint surface/space, around tendon/ligament/nerve/blood vessel, underneath mucosa, etc. Fascia can be strained during movements along with skin and muscle. A strained fascia usually presents excruciating pain several times more than muscle pain. It responds to injury by tightening into wrinkles, thickness, denseness, small and tiny nodes. They are extremely tender upon light touch that one can hardly tolerate. Therefore, movements are limited due to such pain, most commonly seen in so-called “frozen shoulder”.

There is a physiological phenomenon that human or animal body responds to soft tissue injury by surrounding soft tissue wrapping around the injured sites as a protective mechanism, resulting in varying degrees and sizes of thickness, denseness, bumps, nodules, tight bands or bundles. These protective changes can be restored by applying touch-and-hold technique to the precise injured sites, giving the body a signal so that it will respond and soften, eventually releasing and resolving the injury with no more pain. This phenomenon is much like Mimosa (sleeping grass) leaves immediately withdrawing in response to light touch, but not to pressure, light, heat, vibration, manipulation, and thus may be called “Mimosa effect”; but it does not occur without light touch. Such newly-discovered physiological response in animals or humans is hereby termed as “Jou effect” and is applicable in the currently disclosed Precision Method for treatment of pain.

Never in the human history of medicine, a brand new approach is developed and established, which can actually cure all kinds of pain due to soft tissue (muscle and fascia) injury, with a simple and easy treatment; i.e., Precision Method of the present invention. This method is characterized and summarized as follows:

1. Pain is derived from soft tissue injury, namely muscle and fascia.

2. Injured sites can be identified precisely through manual examination of muscle, its attachment or fascia by palpation of tenderness, tightness, thickness, denseness, as well as by testing range of motion or muscle strength of a body part, posture, gait, etc. Expensive tests are not needed.

3. Injury can be resolved and pain removed, site after site, through constant light touching and holding still for a while; i.e., touch-and-hold technique precisely on the injured site, hereby termed as “Precision Method”.

This method can be applied to all kinds of pain from head to toe, and effectively resolve the pain, including acute and chronic pain in the head, face, TMJ, neck, shoulder, arm, hand, fingers, rib cage, breast, abdomen, back, spine, pubis, perineum, tailbone, hip, thigh, knee, leg, ankle, foot, heel, toes; as well as many pain-related conditions such as: fibromyalgia, chronic fatigue syndrome, pre-menstrual syndrome, endometriosis, hot flash, shingles pain, post-polio syndrome, post-stroke, post-operative non-surgical pain, concussion, contusion, burn, wound, postural deviations (scoliosis, kyphosis), migraine headache, scalp numbness, scalp noise, dizziness, tinnitus, motion sickness, blurred vision, eye blinking, drooping eyelid, ingrown eyelashes, incomplete eyelid closure, strabismus, earache, plugged ears, facial tic, facial numbness, trigeminal neuralgia, Bell's palsy, lockjaw, dropped jaw, burning mouth syndrome, loss of taste, restless lips, dropped head syndrome, spasmodic torticollis, restless neck, hiccups, belching, nausea, dysphagia, snoring, vocal cord dysfunction, frozen shoulder, habitual shoulder dislocation, thoracic outlet syndrome, complex regional pain syndrome, tennis elbow, de Quervain's disease, restless hand, wrist drop, carpal tunnel syndrome, trigger finger, Dupuytren's contracture, focal dystonia, soft tissue bulge, costochondritis, Tietze's syndrome, intercostal neuritis, sleep apnea, irritable bowel syndrome, acid reflux, hiatal hernia, stomach cramps, irritable bladder, urgency/frequency/stress incontinence of urine and bowel movements, Peyronie's disease, erectile dysfunction, sexual pain, vaginal tightness, vaginal laxity, prolapse of vagina/uterus/hemorrhoids/rectum, varicose veins, leg stump pain, phantom limb pain, shin splints, leg cramp, restless legs syndrome, Achilles' tendon tightness, plantar fasciitis, neuroma, Ledderhose disease, shuffling gait, bunion, club foot, hammer/claw/mallet toes, edema/numbness/coldness in the hand and foot, etc.

Some aspects of the invention provide a method for treatment of pain, comprising: (a) locating the painful site of a strained muscle, its attachment or fascia by palpation with one or more fingertips in an area of apparent pain, subtle symptom of pain or subtle sign of pain in an animal or human body; and (b) applying a touch-and-hold technique with constant light touch using one or more fingertips precisely to the injured tissue at the site and holding still for a duration at the site, thus giving the body a signal so that the injured tissue at the site responds to the “touch” and softens during the duration of the “hold”, thereby releasing and resolving the pain at the painful site.

In one embodiment of the method of the present invention, the locating step comprises palpation with one or more fingertips in the areas of pain at rest or upon movements.

In one embodiment of the method of the present invention, the applying step comprises constant light touch precisely to the injured tissue at the painful site. In another embodiment, light touch is provided from one or more fingertips of a healthcare provider, wherein light touch is with a pressure between about 0.001 and about 5 psi, usually between about 0.01 and about 1 psi, and most preferably between about 0.1 and about 0.5 psi. The pressure from light touch is substantially constant.

In one embodiment of the method of the present invention, the applying step comprises applying constant light touch precisely to the injured tissue at the painful site and holding still for a duration about 10 seconds to 10 minutes, usually about 1-5 minutes, and most commonly about 2-3 minutes. This requirement of “applying constant light touch and holding still for a duration” is a necessary part of the touch-and-hold technique. Regarding “hold”, one would hold still until pain disappears, usually it takes about 10 seconds to 10 minutes. In one embodiment, the combination of “constant light touch” and “holding still for a needed duration” as disclosed herein is to give the body a signal so that the injured tissue at the site responds to the “touch” and softens during the duration of the “hold”.

In one embodiment of the method of the present invention, the pain at the painful site is any of an apparent pain, a subtle symptom of pain and a subtle sign of pain.

In one embodiment of the method of the present invention, the locating step comprises testing range of motion or muscle strength of a body part.

In one embodiment of the method of the present invention, a device or instrument may be used as a substitute of at least one finger that applies constant light touch to the painful site and holds still for a duration.

In one embodiment of the method of the present invention, a robotic arm connected to a powered machine with a computer control mechanism for automation may be used as a substitute of at least one finger that applies constant light touch to the painful site and holds still for a duration.

In one embodiment of the method of the present invention, the method further comprises a stretch-and-hold technique after the touch-and-hold technique, wherein a healthcare provider applies or instructs a patient to apply stretching, as a supplemental step when medically indicated, gently up to a point of slight tightness or discomfort of the painful site and holding still at the position of the stretching for a duration of about 10 to 60 seconds.

Further, some aspects of the invention relate to a method of treatment for treating pain derived from an injured tissue site in a subject in need of such treatment, wherein the injured tissue site is situated in at least one of injured muscle, injured muscle attachment on the bone, and injured fascia, the method comprising: (a) identifying and locating subtle soft tissue structural changes using one or more fingertips in the subject by palpating the at least one of injured muscle, injured muscle attachment on the bone, and injured fascia, for tenderness, tightness, thickness, wrinkles, bulging nodules, tense bands, tight bundles, unevenness, or denseness; and (b) testing a range of motion or muscle strength of a body part, posture, gait, etc.; and (c) applying constant light touch in a touch-and-hold technique using one or more fingertips precisely on the at least one of injured muscle, injured muscle attachment on the bone, and injured fascia, and holding still for a duration of 1 minute to 5 minutes and at a pressure range between 0.001 and 5 psi and wherein the pressure is substantially constant; wherein the structural changes return to a normal state, the tenderness disappears, the pain is removed and the injury is resolved; and (d) applying gentle stretching to the injured muscle after the touch-and-hold technique, using a stretch-and-hold technique, as a supplemental step when medically indicated, up to a point of slight tightness or discomfort, and holding still for a duration of 10 to 60 seconds to maintain or increase flexibility of the injured muscles in order to avoid regression or recurrence of tightness in the injured muscles.

Some aspects of the invention provide a method for treatment of pain at injured tissue of muscles or fasciae in a painful site, comprising: (a) locating the painful site in a patient; (b) applying a touch-and-hold technique to the painful site as an intervention, wherein the technique comprises applying constant light touch using at least one fingertip precisely on the site and holding still for a duration at the site; and (c) thus enabling structural changes of the injured tissue of the muscles or fasciae having pain, tenderness, tightness or dysfunction at the painful site to restore the structural changes during the duration, resulting in relief of pain, tenderness, tightness or dysfunction. In one embodiment, the structural change is associated with a certain painful substance, which is not yet clearly identified. In one embodiment, the structural changes in the injured tissue of the muscles or fasciae remain persistent with no spontaneous recovery and wherein restoration of the structural changes of the injured tissue of the muscles or fasciae does not occur without the intervention of the touch-and-hold technique.

Some aspects of the invention provide a method for treatment of pain at injured tissue of muscles or fasciae in a painful site further comprising applying a stretch-and-hold technique to the muscles as a supplemental step when medically indicated, wherein the stretch-and-hold technique comprises a step of applying gentle stretching up to a point of slight tightness or discomfort at the painful site, and holds still for a duration in order to avoid regression or recurrence of tightness in the injured muscles. In one embodiment, the duration of the step of applying the gentle stretching is between about 10 and 60 seconds.

### BRIEF DESCRIPTION OF THE DRAWINGS

Additional objects and features of the present invention will become more apparent and the invention itself will be best understood from the following detailed Description of Exemplary Embodiments, when read with reference to the accompanying drawing.

FIG. 1 shows one example of a Physical Medicine Prescription form documenting physical findings of injured soft tissue; based on which diagnosis is established, therapy is prescribed, outcome of therapy as well as progress of patient can also be measured and monitored.

### DESCRIPTION OF EXEMPLARY EMBODIMENTS

The preferred embodiments of the present invention described below relate particularly to the Precision Method for treating pain of a patient with touch-and-hold technique, supplemented by stretch-and-hold technique when medically indicated. While the description sets forth various embodiment specific details, it will be appreciated that the description is illustrative only and should not be construed in any way as limiting the invention. Furthermore, various applications of the invention, and modifications thereto, which may occur to those who are skilled in the art, are also encompassed by the general concepts described below.

As used herein, the term “Precision Method” shall refer to a treatment method for treatment of pain precisely on an injured soft tissue site in animals or humans. “Precisely” means a treatment method being applied on an injured site, but not on surrounding normal uninjured site or any other non-specific sites.

As used herein, the term “touch-and-hold” shall refer to a treatment method for treatment of pain on an injured tissue site with constant light touch (relating to the term “touch”) and holding still for a duration (relating to the term “hold”) in animals or humans.

Injured sites can be precisely identified by palpation, based on the above expanded definition of pain. The apparent pain is indicative of tenderness of the injured sites that can be palpated in the painful areas at rest or upon movements. The subtle symptom of pain is indicative of tenderness of the injured sites that can be palpated in the areas of such subtle symptoms at rest or upon movements. The subtle sign of pain is indicative of tenderness of the injured sites that can be found in the areas of bulging/tightness, or limited range of motion of a body part, or limited strength of specific muscle by muscle testing, or specific muscles related to postural/gait changes, etc.

The tenderness is derived from injury to the muscle, muscle attachment on the bone, or fascia. Therefore the injured site is always tender, and tenderness always indicates injury. Injury manifests into three categories as described previously. For example, when there is tightness, there must be tenderness, indicating injury inside the tight tissue. There are subtle structural changes in the injured site, different from normal tissue. Upon careful palpation, such changes can be felt; i.e., tightness, denseness, thickness, wrinkles, bulging nodules, tense bands, tight bundles, unevenness, etc.

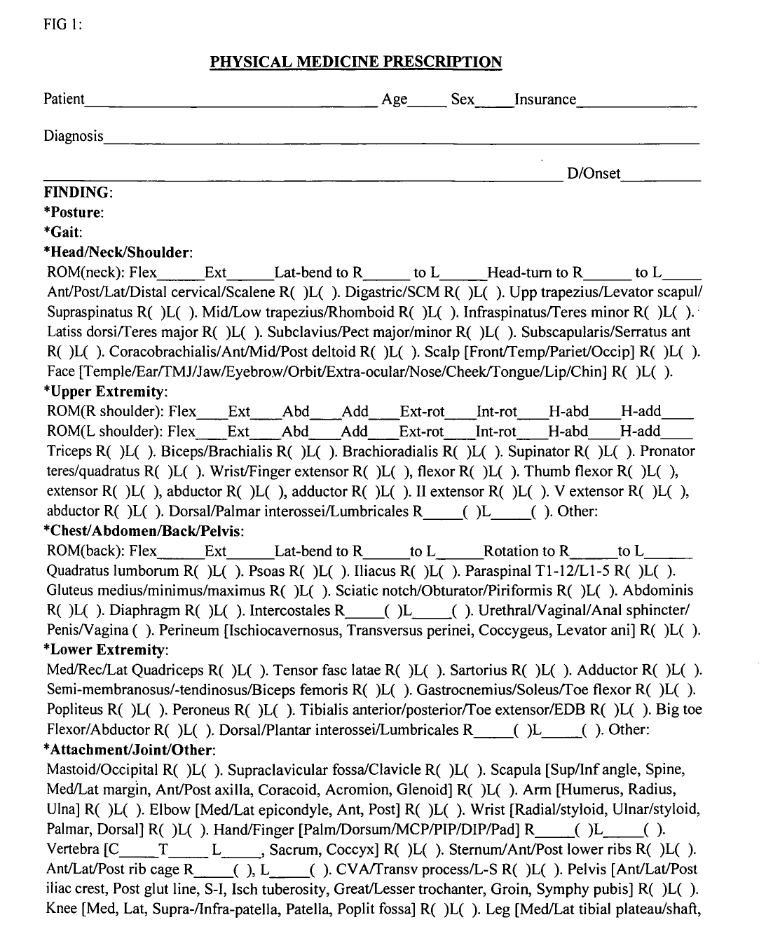

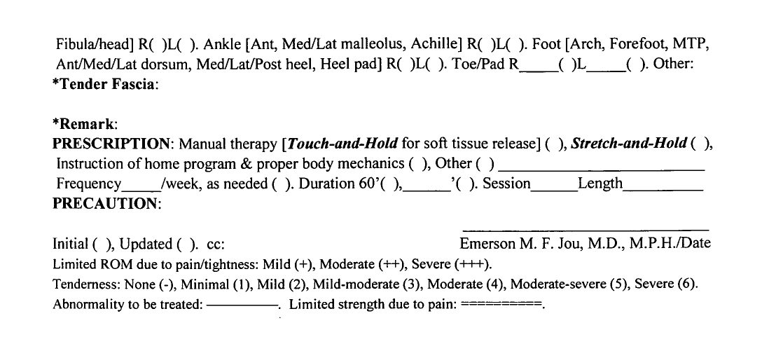

The findings of such manual examination are then documented in the attached (FIG. 1) “Physical Medicine Prescription” in terms of location and degree of tenderness in muscles and their attachments, ROM (range of motion), posture, gait, tender fascia, etc. This is the basis for establishing diagnosis and prescribing therapy, as well as measuring and monitoring progress.

Once an injured site is identified, a touch-and-hold technique is applied with one or more fingertips lightly right on it for awhile (i.e., constant light touching and holding still for a duration). During the process, one can feel at the tip of fingers that the injured tissue immediately responds to soften and release. As part of the response, fine twitching of muscle along with fascia tissue can often be felt like pulsating sensation. In one embodiment, the use of at least one fingertip in this method may be substituted with a device or instrument applying constant light touch manually or a robotic arm connected to a powered machine with computer control for automation. In general, the touch-and-hold technique applies a pressure between about 0.001 and about 5 psi, usually between about 0.01 and about 1 psi, and most preferably between about 0.1 and about 0.5 psi.

Eventually, these structural changes at the injured site will reverse to a normal state, thus tenderness disappears, pain is removed and injury resolved. The duration for touch-and-hold may range from about 10 seconds to 10 minutes or longer, usually about 1-5 minutes, most commonly about 2-3 minutes, depending on how stubborn the injury is. Regardless of its severity or chronicity, tenderness and pain will eventually disappear. The same can be applied to all conditions of pain mentioned above. In one embodiment, the combination of “constant light touching” and “holding still for a needed duration” as disclosed herein is to give the body a signal so that the injured tissue at the site responds to the “touch” and softens during the duration of the “hold”.

After treatment with the touch-and-hold technique, a stretch-and-hold technique is applied to the injured sites as a supplemental step when medically indicated. A healthcare provider applies or instructs a patient to apply stretching, gently up to the point of slight tightness and/or discomfort and hold still the position, but no forceful stretching, for a duration of about 10 to 60 seconds, preferably about 30 seconds, for as many repetitions and as frequent as necessary to maintain or increase flexibility of the injured muscles in order to avoid regression or recurrence of tightness in the injured muscles.

In some preferred embodiment, for example, in so-called “frozen shoulder” with limitation in ROM (range of motion) of shoulder joint, numerous tender spots of fascia can be found upon any given ROM at the point of limitation. Using the Precision Method, once touch-and-hold technique is applied to these spots for awhile, tenderness disappears and thus ROM immediately increases. After substantial removal of these tender spots, ROM can be fully restored and “frozen shoulder” recovered.

In another preferred embodiment, for example, in so-called “tennis elbow” in the elbow as well as above and below the elbow, tenderness along with the above-mentioned structural changes can be palpated on the muscles, muscle attachments on the bone, fascia in the joint space and between muscle bundles. Using the Precision Method of the present invention, once touch-and-hold technique is applied to these tender areas for awhile, tenderness and tightness disappear, movements and strength can be restored, and “tennis elbow” recovered.

The touch-and hold precision method of the present invention is fundamentally different from the conventional chiropractic manipulation, massage or acupressure. Chiropractic manipulation adjusts alignment of various joints. Massage presses hard, roughly and intermittently to general large areas with no regard to many specific small and tiny injured sites of muscle, muscle attachment or fascia. Acupressure applies heavy pressure only on the acupuncture points instead of specific injured sites. Whereas the touch-and-hold precision method applies constant light touch to a precise soft tissue injured site and holds still for a duration, thereby giving the body a signal so that the injured tissue will respond and soften.

In a further embodiment, the soft tissue injury manifests into three categories: apparent pain (all kinds of pain), subtle symptom (mild aching, tightness, altered sensation) or subtle sign (limited motion/strength/endurance, postural/gait changes). The soft tissue injury causes subtle structural changes in muscles or fasciae at the injured sites where the surrounding tissue wraps around the injured sites as a protective mechanism, resulting in varying degrees and sizes of tenderness, tightness, denseness, thickness, bumps, wrinkles, bulging nodules, tense bands, tight bundles, unevenness, etc. This is how the human body reacts to soft tissue injury as a physiological response. All of these protective changes in terms of symptoms, signs and structural changes can be detected and measured manually before and after treatment. These symptoms, signs and structural changes remain persistent until treated. This treatment is an intervention and not a natural or spontaneous process. In soft tissue injury with or without inflammation, there produces a certain painful substance in the soft tissue at the injured sites that can be resolved or removed by light touch via an undetermined physiological mechanism, but this substance will persist and remain unchanged for a lifetime without such a treatment.

The structural changes in a soft tissue injury can be restored by applying the touch-and-hold precision method to the precise injured sites, giving the body a signal so that it will respond and soften, eventually releasing and resolving the injury with no more pain. This method can reverse the structural changes definitely transforming an injured muscle or fascia from a state of injured tissue to a different state of normal tissue. The muscle thus treated using the method is transformed from an injured state with pain, tightness or impaired function (limited range of motion, limited strength, postural/gait changes) to the resolved uninjured state with normal function and no pain or tightness. The injured muscle before the treatment does not function like how a normal muscle should; i.e., limited function or non-function because of pain and/or limitations in an injured tissue site. This muscle after the treatment is reverted to be functional without associated pain and/or limitations. By resolving such structural changes, this method can actually cure all kinds of pain and pain-related conditions, such as frozen shoulder, tennis elbow, trigger finger, restless leg syndrome, spasmodic torticollis, irritable bowel syndrome, postural deviations, leg-length discrepancy, etc. Thus, this method transforms a state of abnormal medical condition to a different state of normal healthy condition. There is a definite effect by the intervention of this method with specific structural and physiological responses similar to “Mimosa effect”. Eventually, these structural changes at the injured site will reverse to normal state, thus tenderness disappears, pain is removed and injury resolved. Such resolution of injury is not a natural phenomenon at all, because it does not occur without an intervention; i.e., touch-and-hold precision method.

In short, this method is a medical treatment aiming to cure pain by restoration and recovery of physical dysfunction due to soft tissue injury. It is not intended (and it is not possible) to transform soft tissue (muscle, fascia) to different entities, but rather, to transform from a state of injury with impaired function to a state of health with normal function. It restores structural changes of injury to a normal condition, but those changes will not occur and will remain unchanged for a lifetime without such a treatment.

In U.S. Pat. No. 5,239,986 prior art (“Method of Normalizing Soft Tissue Dysfunction”), the entire contents of which are incorporated herein by reference, Hermelin discloses a process of normalizing soft tissue for alleviation of pain and alignment of the body in a human subject by a massage therapist that includes the steps of locating dysfunctional soft tissues in the body, lightly palpating the area in such a way as to detect restrictions in the skin in the form of knots, detecting rope-like barriers or patterns, sensing the potential movement of the patterns, allowing the presence of the therapist's fingers to stimulate and follow movement of the patterns, applying sweeping motion with the fingers of the therapist without substantial force. This method is based upon the observations that soft tissue dysfunction is reflected by patterns in the skin. Whereas, the instant invention does not rely on skin patterns for diagnosis or treatment. It locates injured tissue by palpation of painful sites at rest or upon movements following evaluation of range of motion, muscle strength, postural changes, gait, etc. but not by detection of skin restrictions in the form of knots. It applies constant light touch and holds still but without sweeping motion to stimulate and follow movement of patterns.

In U.S. patent application publication 2003/0199792 prior art, Austin teaches a method by applying external pressure by way of reflexology to reduce pain. Austin uses fingers, knuckles, hands, fists, forearms and elbows in varying degree of pressure and direction, along with manual manipulation and facilitation of soft tissues. The instant method applies constant light touch to a precise injured tissue site and holds still for a duration using one or more fingertips, giving a signal for body response (a newly-discovered physiological phenomenon similar to “Mimosa effect”). There is no change of pressure or direction, no manipulation or facilitation of soft tissues and no reflexology involved.

Furthermore, Austin discloses that the stimulation can take the form of external pressure applied to the application points. The instant method applies light touch to give the body a signal to initiate body response, not a “stimulation”.

Austin discloses that the exertion of external pressure by the health practitioner or patient on the soft tissue associated with the application point(s) can involve the application of pressure directed simultaneously and/or concurrently downward with oblique, semicircular, lengthwise or transverse pressure. Austin also discloses that his application may also involve a tractional rolling or scooping of movement. Austin uses tissue manipulation and stretching, whereas the instant method applies only constant light touch and holds still with no varying “degree of pressure”, particularly no “downward with oblique, semicircular, lengthwise or transverse pressure”, no “tractional rolling” or “scooping” movement, and no manipulation or stretching.

Austin further discloses that, as the patient breathes out, he or she pushes up on the elbow while simultaneously pulling the elbow down and pressing deeply into the tender spot. The patient may also bring the elbow of the side of involvement upward during the application of pressure at the application point and lowers the scapula out of the way to allow for deeper penetration. The instant claim discloses a touch-and-hold technique, not “pressing deeply into the tender spot”, or “to allow for deeper penetration”.

Austin starts out with sufficient pressure, then more pressure to go deeper, also dynamic pressure with two directional axes, further with manipulation and facilitation, lengthening (stretching) and strengthening. Whereas, muscle strengthening and lengthening are detrimental and thus purposefully excluded according to the teaching of the instant method, which states that once pain is removed, muscle strength and tightness return to normal immediately thereafter.

In short, Austin uses force (much more than touch) for stimulation, manipulation, stretching and strengthening, but never uses “touch” or “hold” throughout his method, whereas the instant method applies only constant light touch and holds still with no manipulation or stretching, wherein the pressure from the light touch is substantially constant.

The substantial differences are summarized in the following table for differentiation. It shows that the instant invention differs greatly from and is not a derivative of Austin's disclosure prior art.

| | Precision Method | Austin's Method |
|---|---|---|
| | The instant invention | A prior art |
| Method | Constant light touch and hold still. | External deep pressure for stimulation, |
| | Stimulation, stretching and manipulation | stretching, manipulation, rolling and |
| | are detrimental and thus prohibited | scooping |
| Pressure | Constant light touch and hold still with | Varying degree of pressure and |
| | pressure range from 0.001 to 5 psi | direction, pressure range unspecified |
| Duration | 10 seconds to 10 minutes | 7 seconds for stimulation, unspecified |
| | | duration for stretching/manipulation |
| Technique | Using fingertips for light touch | Using fingers, knuckles, hands, fists, |
| | | forearms, elbows for deep pressure |
| Strengthening/lengthening | Detrimental and thus prohibited, muscle | Strengthen weak muscles and lengthen |
| | strength and length can be restored | tight muscles |
| | simply by this method | |
| Targeted conditions | Pain is derived from muscle and fascia | Fascia adhesion, nerve adhesion, |
| | strain, not tendon, ligament, bone, joint, | muscle spasm/fibrosis/inflammation/ |
| | nerve, inflammation, adhesion, fibrosis | contracture |
| Targeted body parts | Anywhere in the body, including tough | Limited to tendons, capsules, |
| | heel pad, soft eyelid, mucosal lip, tiny | ligaments, skin, scar tissue, |
| | nostril, hidden urethral sphincter, . . . | periosteum, and those allowable for |
| | etc., in addition to muscles and fasciae | stretching/manipulation |
| Background | Western medicine with a totally new | Western + alternative medicine with |
| | perspective, but none of the elements of | energy flow, acupressure, meridians, |
| | the alternative medicine | acupuncture points |
| Mechanism | “Mimosa effect” upon light touch | Reflexology by forceful stimulation |
| Outcome | Cure pain and all pain-related conditions | Reduce pain in the treated muscles |

In U.S. Pat. No. 5,113,847 prior art, Holzworth discloses that when applying pressure, the amount of pressure applied should extend through the sensations of tenderness and up to the point of pain, but not into the pain level. As tenderness and pain begin to subside, an individual may slightly increase the pressure and hold it for 5-10 seconds. The invention disclosed herein that it uses a device to stimulate intramuscular fluid pressure in a manner similar to Shiatzu therapy with resultant muscle spindle desensitivity and concomitant relaxation. Additionally, this device generates enough gentle pressure to stretch lock actin and myosin filaments apart to terminate runaway contracture activity. Furthermore, the device generates enough pressure to force trapped intramuscular fluid from the intrafascicular and tendinous noncontractile hiding places towards positions of high metabolic activity and good circulation and alters Starling's equilibrium to favor fluid displacement into circulation. His teaching differs greatly from the present touch-and-hold precision method. The substantial differences between Holzworth's prior art and the instant invention are noted in parentheses as follows.

Holzworth applies pressure between the points of tenderness and pain “extending through the sensations of tenderness and up to the point of pain”, and “slightly increases the pressure and holds it for 5-10 seconds”. It uses a device to stimulate “intramuscular fluid pressure”, “to generate enough gentle pressure to stretch lock actin and myosin filaments” and “to force trapped intramuscular fluid into circulation”, “in a manner similar to Shiatzu therapy”. It “permits the tools to be heated”. In short, Holzworth uses a device (not fingertips), applies pressure (not light touch), increases pressure (not constant pressure) for 5-10 seconds (not 1-5 minutes), utilizes heat (no use of heat), stimulates “intramuscular fluid pressure” (not “Mimosa effect”) in a manner similar to Shiatzu therapy (not Shiatzu).

In U.S. patent application publication 2008/0306418 prior art, DeBenedictis teaches the bursts of pressurized gas between about 0.01 pound per square inch (psi) and about 10 psi, or between 0.05 psi and about 5 psi, suitable for reducing pain on a patient's skin. In one embodiment of the present touch-and-hold precision method, constant light touching and holding still with a steady pressure is manually applied to the tissue, but not pressure from a burst gas.

In U.S. Pat. No. 5,501,657 prior art, Feero discloses a first stage stretching and second stage soft tissue manipulation that are preferably applied in alternating sequence. In the prior art, moderate digital pressure, sufficient in intensity to distend the soft tissue but at a level of intensity that invokes little if no discomfort to the patient, is applied along the elongate muscle fibers of the forearm, generally at an angle to the elongate muscle fiber, downwardly and across the muscle fibers for soft tissue manipulation. Whereas, the instant invention applies constant light touch but not moderate pressure sufficient to distend the soft tissue, and no stretching or manipulation involved.

The cited prior art Bothum (“Touch taps spine's hydraulic system”) in view of Holzworth (U.S. Pat. No. 5,113,847) teaches a method that uses hands for “cradle”, “gentle touch” or “light touch” only at skull, legs and sacrum, based on a so-called “hydraulic system” to adjust flow of cerebrospinal fluid. No “hold” ever disclosed or mentioned in prior art Bothum. The instant invention claims a method using fingertips (not hands), for light touch and holding at any painful site anywhere in the body (not limited to skull, legs and sacrum), based on “Mimosa effect” (not “hydraulic system”) to initiate body response for resolution of all kinds of soft tissue injury with no more pain.

In U.S. patent application publication 2009/0227916 prior art, Gohl relates to massage or manual manipulative therapy for reducing hypertonicity of muscle-tendon bundles. It teaches a method of using the influence of light tactile pressure to ligament receptors to regulate and reprogram muscular stiffness. It uses hand to lengthen muscles in order to identify muscles of hypertonicity, then follows pre-determined referral patterns and shortens the targeted muscle before using hand to apply light to mild static tactile pressure of 3-4 pounds per square inch for 15-30 seconds. Its objectives are to induce correction for musculo-skeletal dysfunction to deliver long lasting and even permanent relief to pathologies, to increase physical performance and to affect the pathologies of the internal organs. All of these objectives are met by influencing ligamentous tissue in facilitating a release of tension of muscles and tendons, reduction of trigger-points, and re-alignment of tissue, thereby assisting in the correction of dysfunction.

The substantial differences are summarized in the following table for claim differentiation. It shows that the claims of the instant invention differ greatly from and are not a derivative of Gohl's disclosure prior art.

| | Precision Method | Gohl's Method |
|---|---|---|
| | The instant invention | A prior art |
| Method | Constant light touch and hold still | External pressure on the ligaments of |
| | precisely on the injured (painful) sites | joints following pre-determined |
| | anywhere in the body | referral patterns |
| Pressure | Constant light touch and hold still with | Light to mild static tactile pressure of |
| | pressure range from 0.001 to 5 psi | 3-4 pounds per square inch |
| Duration | 10 seconds to 10 minutes | 15-30 seconds |
| Technique | Using fingertips for light touch | Using hands for tactile pressure |
| Muscle tension and | Muscle lengthening or release of muscle | Muscle lengthening by reducing |
| lengthening | tension is neither an objective nor a part | muscle tension |
| | of the method | |
| Targeted conditions | All types of pain derived from muscle | Musculo-skeletal dysfunction due to |
| | and/or fascia strain as well as all pain- | hypertonicity and pathology of |
| | related conditions | internal organs |
| Targeted body parts | Fasciae, muscles and their attachments | Limited to ligament receptors |
| | anywhere in the body, e.g. head, neck, | |
| | shoulder, arm, hand, back, hip, leg, foot, | |
| | and even heel pad, eyelid, oral mucosa, | |
| | nostril, urethral sphincter; but ligaments | |
| | are not included as a part of treatment | |
| Background | Western medicine with a totally new | Massage and manipulative therapy |
| | perspective | |
| Mechanism | Based on “Mimosa effect” by light | Modification of muscle tonicity by |
| | touch, thus injured tissue softens and | applying pressure on the ligament |
| | structural changes resolved, then pain | receptors |
| | and tenderness disappear | |
| Outcome | Cure pain and all pain-related conditions | Reduce tension and improve |
| | | lengthening in the muscles associated |
| | | with treated ligaments |

The cited prior art Rubenstein (U.S. 2008/0243034) uses Fascial Release System for fascia decompression in the head, torso and limbs. His method consists of two parts: Cranial Decompression and the Series 8. In Cranial Decompression, he uses fingers or hand to apply a combination of compressional pressure movement and tractional force movement from a multitude of directions inward toward the core of the cranium repeatedly to promote natural elongation of fascia. In the Series 8, he applies stretching in various postures into four segments from the head along the dorsal line of accumulated force through neck, torso, hips and legs down to feet using an orientation marker, a platform and a balancing aid to promote a systematic full-bodied decompression of imbalance tensions.

Whereas, the instant invention is applied precisely at the injured or painful sites to resolve the injury with no more pain. Treating an injury in the head has no effect in resolving an injury elsewhere, and vise versa. An injury elsewhere must be treated at its precise location, site after site, and not indirectly from a distance or by systematic approach treating the full body. The instant invention; i.e., touch-and-hold precision method, applies constant light touch for a duration without repetition until pain subsides, but not compressional pressure movement and tractional force movement repeatedly. The instant invention treats pain derived from soft tissue injury in the muscle, its attachment and fascia, not only fascia. After treatment with touch-and- hold technique, a healthcare provider applies or instructs a patient to apply gentle stretching; i.e., stretch-and-hold technique, to the injured sites for a duration to maintain or increase flexibility in order to avoid regression or recurrence. Stretching of fascia is detrimental and prohibited because it does not resolve or prevent fascia injury but actually aggravates the injury instead. Therefore, it is not an element of the instant invention.

The substantial differences are summarized in the following table for claim differentiation. It shows that the claims of the instant invention differ greatly from and are not a derivative of Rubenstein's disclosure prior art.

| | Precision Method | Rubenstein's Method |
|---|---|---|
| | The instant invention | A prior art |
| Method | Constant light touch and hold still | Compressive force and tractional force |
| | precisely on the injured (painful) sites | inward toward the core of the head, |
| | anywhere in the body | combing with stretching of fascia in |
| | | the torso and limbs |
| Pressure | Constant light touch and hold still with | Enough pressure |
| | pressure range from 0.001 to 5 psi | |
| Duration | 10 seconds to 10 minutes with no | Several seconds with repetition until a |
| | repetition until pain disappears | release is detected |
| Technique | Using fingertips to apply light touch and | Using fingers and hands to apply |
| | hold still, site after site, but no | compressional pressure movement and |
| | compression, traction or movement. | tractional force movement from |
| | Stretching of fascia is detrimental and | multiple directions on the cranium |
| | prohibited. No use of devices. | together with stretching of fascia |
| | | along the dorsal line down to the feet |
| | | in various postures aided by devices |
| Targeted conditions | All types of pain derived from muscle | Pain resulting from imbalanced |
| | and/or fascia strain as well as all pain- | tensions in the connective tissues in |
| | related conditions | the head, torso and limbs |
| Targeted body parts | Fasciae, muscles and their attachments | Limited to fascia tissue in the head |
| | anywhere in the body, e.g. head, neck, | and along the dorsal line through |
| | shoulder, arm, hand, back, hip, leg, foot, | neck, torso, hips, legs down to feet |
| | and even heel pad, eyelid, oral mucosa, | |
| | nostril, urethral sphincter | |
| Background | Western medicine with a totally new | Massage and manipulative therapy |
| | perspective | |
| Mechanism | Based on “Mimosa effect” by light | Decompression of compressed fascia |
| | touch, thus injured tissue softens and | tissues in the cranium together with |
| | structural changes resolved, then pain | stretching of fascia in the torso and |
| | and tenderness disappear | limbs to promote a systematic full- |
| | | bodied decompression of imbalance |
| | | tensions |
| Outcome | Cure pain and all pain-related conditions | Reduce pain, fascia tension and |
| | | rigidity in the head, torso and limbs |

From the foregoing, it should now be appreciated that a method for treatment of pain with the touch-and-hold precision method has been disclosed. While the invention has been described with reference to a specific embodiment, the description is illustrative of the invention and is not to be construed as limiting the invention. Various modifications and applications may occur to those skilled in the art without departing from the true spirit and scope of the invention as described by the appended claims.

What is claimed is:

1. A method for treatment of pain at injured tissue of muscles or fasciae in a painful site, comprising:
(a) locating the painful site in a patient; and
(b) applying a touch-and-hold technique to the painful site as an intervention, wherein the technique comprises applying constant light touch using at least one fingertip precisely on said site and holding still for a duration at said site; and
(c) thus enabling structural changes with a certain painful substance of said injured tissue of said muscles or fasciae having pain, tenderness, tightness or dysfunction at said painful site to restore said structural changes during said duration, resulting in relief of pain, tenderness, tightness or dysfunction.

2. The method according to claim 1, further comprising applying a stretch-and-hold technique to said muscles when medically indicated, wherein the stretch-and-hold technique comprises a step of applying gentle stretching up to a point of slight tightness or discomfort at said painful site, and holds still for a duration in order to avoid regression or recurrence of tightness in said muscles.

3. The method according to claim 2, wherein the duration of the step of applying said gentle stretching is between about 10 and 60 seconds.

4. The method according to claim 1, wherein said structural changes in said injured tissue of said muscles or fasciae remain persistent with no spontaneous recovery and wherein restoration of said structural changes of said injured tissue of said muscles or fasciae does not occur without said intervention of said touch-and-hold technique.

5. The method according to claim 1, wherein the locating step comprises palpation in areas of the painful site at rest or upon movements.

6. The method according to claim 1, wherein said light touch is provided with a pressure between about 0.001 and about 5 psi.

7. The method according to claim 1, wherein said light touch is provided with a pressure between about 0.01 and about 1 psi.

8. The method according to claim 1, wherein said light touch is provided with a pressure between about 0.1 and about 0.5 psi.

9. The method according to claim 1, wherein said duration is about 10 seconds to 10 minutes.

10. The method according to claim 1, wherein said duration is about 1 to 5 minutes.

11. The method according to claim 1, wherein said duration is about 2 to 3 minutes.

12. The method according to claim 1, wherein the pain at the painful site is caused by a strained muscle, its attachment or fascia.

13. The method according to claim 1, wherein the pain at the painful site is any of an apparent pain, a subtle symptom of pain and a subtle sign of pain.

14. The method according to claim 1, wherein the locating step comprises testing range of motion or muscle strength of a body part.

15. The method according to claim 1, wherein a device or instrument is substituted to provide said light touch to said painful site.

16. The method according to claim 1, wherein a robotic arm is substituted to provide said light touch to said painful site.
